(19) United States
(12) Patent Application Publication
(10) Pub. No.: US 2002/0103910 A1
(43) Pub. Date: Aug. 1, 2002

(54) Method and server for accessing a digital network and system comprising such a server

(76) Inventors: Gwenael Le Lay, Lannion (FR); Jean-Francois Lamard, Lannion (FR); Marc Le Ligne, Tregastel (FR)

Correspondence Address: MARSHALL, GERSTEIN & BORUN, 6300 SEARS TOWER, 233 SOUTH WACKER, CHICAGO, IL, 60606-6357, US

(21) Appl. No.: 09/810,590

(22) Filed: Mar. 16, 2001

(30) Foreign Application Priority Data
Jan. 31, 2001 (FR) FR 01 01306

(51) Int. Cl. G06F 15/173; G06F 15/16

(52) U.S. Cl. 709/227; 709/223; 709/203

(57) ABSTRACT

The invention enables a connection to be established across a packet mode network between a user terminal and a server of a service provider using one specific connection mode of a plurality of different connection modes supported by the digital network, whereby the specific connection mode is identified on the basis of data transmitted by the user terminal, at least one service access server is selected, depending on the specific connection mode, from a plurality of service access servers, such that the selected service access server is compatible with the specific connection mode, and at least one call accounting message is transmitted to the at least one selected service access server.

### TECHNICAL FIELD

The present invention relates to a method and a server for accessing a digital network, in particular a packet mode transport network, and a system comprising such a server.

### BACKGROUND OF THE INVENTION

It relates to the field of digital networks, and in particular packet mode transport networks, supporting a protocol such as TCP/IP (Transmission Control Protocol/Internet Protocol), for example.

A network access server is an equipment designed to interconnect an access network with the transport network. The purpose of the access network is to collect the data flows from user terminals linked to the access network. Servers of different providers or ISPs (Internet Service Providers) are linked to the transport network. When a user wants to access a service of an ISP, a connection has to be established between the user terminal and the ISP server.

Depending on the type of service concerned and/or depending on the ISP, such connections may be made in different respective connection modes. The modes more particularly used with the IP networks (Internet Protocol) are SLIP mode (Serial Llne Protocol), L2TP mode (Level 2 Tunneling Protocol) or TCP-raw mode (Transmission Control Protocol-Raw). The network access server is said to be mutualized when it permits access to services requiring connections to be made using different connection modes. These connection modes are associated with one or more respective services. A mutualized access server therefore accepts connections in several different connection modes associated with one or more respective services.

In order to access certain services, authentication messages are exchanged between the user terminal, the network access server, the ISP's server and/or a specific server known as the service access server, which is linked to the transport network. The purpose of these messages is to enable the user to be identified and check that he is authorised to access the service (for example because he has taken out a subscription to this end).

Generally speaking, accounting messages are also exchanged between the user terminal and/or the network access server on the one hand and the service access server on the other. For statistical and/or billing purposes, these messages are exchanged in particular when a connection is established (known as accounting start messages) and when the connection is released (accounting stop messages).

However, a problem arises due to the fact that some of the equipments currently installed as access servers to the services are incompatible with certain specific connection modes. For example, the service access server linked to the IP network core of the French operator FRANCE TELECOM, designed by ALCATEL, is not compatible with the TCP-Raw connection mode mentioned above. In practice, accounting messages in this connection mode are transmitted to the service access server without being preceded by authentication messages. These accounting messages are therefore not recognised by the service access server, which responds by generating internode synchronisation messages. This gives rise to an overload of internal traffic on the service access server, which can cause it to become saturated.

In order to avoid this drawback, it would be conceivable to intervene on a level with this server, in order to eliminate overload in internal traffic. However, this would merely get rid of the effects of the problem and not the cause.

It would also be conceivable to modify the profile of the network access server (mutualized server) so that it simulates a connection mode compatible with the service access server. As an example, this would be tantamount to transmitting authentication messages artificially addressed to the service access server prior to transmitting the accounting messages. However, this has proved difficult to implement as a means of eliminating all the possible causes of incompatibility between a given connection mode and the service access server.

### SUMMARY OF THE INVENTION

The invention proposes a solution to the problem outlined above, which is based on a totally different approach. The invention can be applied if a network access server is mutualized, i.e. if it supports several specific connection modes used to connect a user terminal to the server of any ISP via the transport network, each of these connection modes being associated with one or more respective services, and where a plurality of service access servers are connected to the transport network, each connection mode corresponding to at least one service access server compatible with it. In essence, the invention consists in switching accounting messages of a given connection, depending on the connection mode of the connection, to at least one service access server which is compatible with the connection mode. Accordingly, the accounting messages associated with a given connection are transmitted only to a service access server which is compatible with the corresponding connection mode. Optionally, authentication messages associated with the said given connection are also transmitted to this service access server prior to transmitting said accounting messages.

More specifically, the invention proposes a method of accessing a packet mode network in order to establish a connection across the network between a user terminal and a service provider's server, using one specific connection mode from a plurality of different connection modes supported by the network, comprising the steps of:

identifying said specific connection mode on the basis of data transmitted by the user terminal;

depending on said specific connection mode, selecting at least one service access server from a plurality of service access servers such that the selected service access server is compatible with said specific connection mode;

transmitting at least one accounting message associated with the connection to said selected service access server.

The invention also proposes a packet mode network access server for establishing a connection between a user terminal and a server of a service provider across the network, using one specific connection mode from a plurality of different connection modes supported by the network, comprising:

means for identifying said specific connection mode on the basis of data transmitted by the user terminal;

depending on said specific connection mode, means for selecting at least one service access server from a plurality of service access servers such that the selected service access server is compatible with said specific connection mode;

means for transmitting at least one accounting message associated with the connection to said at least one selected service access server.

Finally, the invention proposes a system comprising a packet mode network, at least one user terminal and at least one server of a service provider, a plurality of service access servers each compatible with at least one connection mode, and at least one network access server to establish a connection across the network between the user terminal and the server of the service provider.

According to additional features, which may be applied individually or in combination:

the user terminal is connected to an access network which is interconnected with the packet mode network by the network access server;

the packet mode network is an IP network (Internet Protocol);

the packet mode network is a backbone network;

the service access servers are RADIUS servers (Remote Authentication Dial-In-User Service), i.e. they operate using the RADIUS protocol (see RFC 2138).

### BRIEF DESCRIPTION OF THE DRAWINGS

Other features and advantages of the invention will become clear from the description given below. It is given purely by way of illustration and should be read in conjunction with the appended drawings, in which:

FIG. 1: is a schematic diagram of the architecture of a system as proposed by the invention;

FIG. 2: is a diagram showing a network access server as proposed by the invention;

FIG. 3: is a flow chart showing the steps of a method as proposed by the invention;

FIG. 4: is a diagram illustrating one example of how the invention may be applied.

### DETAILED DESCRIPTION OF THE INVENTION

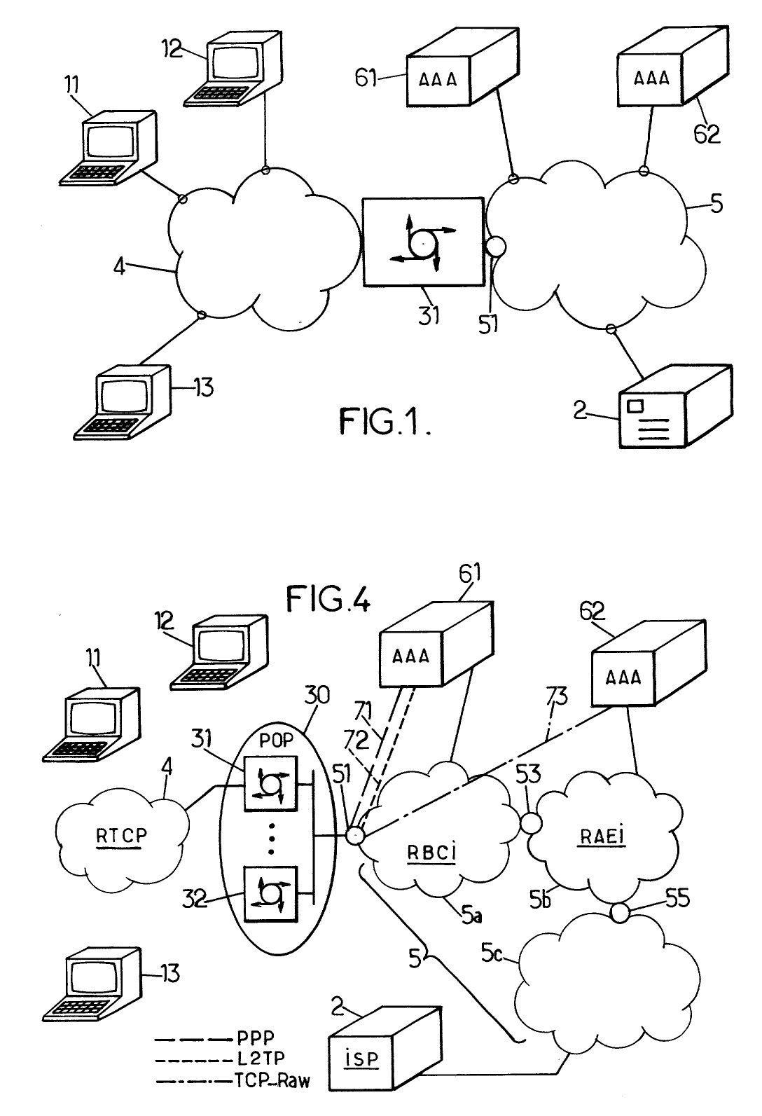

FIG. 1 is a schematic diagram of the architecture of a system as proposed by the invention.

Reference 5 denotes a digital network, in particular a packet mode transport network. It may be an IP network, for example. At least one ISP server 2 is connected to the network 5.

Reference 4 denotes an access network or a subscriber network which may use various technologies to connect these subscribers. For example, it may be a switched telephone network, a wireless communications network such as GSM or UMTS. Alternatively, it may be a local area network or LAN, an ADSL network, or others. User terminals such as 11 to 13 are connected (physically and/or logically) to the access network 4.

The system additionally comprises a plurality of service access servers such as 61 and 62, which are connected to the network 5. They are sometimes referred to as Platform Access Service or PAS. These servers fulfil various functions connected with managing access to the services which can be accessed via the network 5. These functions are commonly referred to by the acronym AAA (Authentication Authorization Accounting). In particular, if a connection has to be established between the terminal of a user and the server of an ISP, authentication messages may be transmitted to a service access server with a view to identifying the user and verifying that he is authorized to access the services offered by the ISP. These messages contain a “login”, for example, i.e. the combination of a user name and password. Similarly, accounting messages are generally transmitted to it when establishing and releasing the connection in order to update information needed for billing users or for statistical reasons. These messages relate to the duration of the connection, the volume of data sent and/or received by the user terminal, etc.

Finally, the system has a network access server 31, which interconnects the access network 4 with the transport network 5. The purpose of the server 31 is to route data flows gathered by the access network 4 to the fist node of the transport network 5. Another of its functions is to transmit the authentication messages and/or the accounting messages to a service access server. If the access network is a narrow band network (typically up to 128 Kb/s), the network access server is commonly known as a NAS (Network Access Server). If, on the other hand, it is a broad band network (typically in the order of 500 Kb/s), the network access server is commonly known as a BAS (Broadband Access Server).

For the purposes of the invention, the server 31 is a mutualized server, i.e., it supports connections using different specific connection modes. Connections are established to enable the user terminals 11 to 13 to link up to a server of an ISP such as the server 2, in order to access a service. Each connection mode is associated with one or more respective services. When a connection is being set up, the connection mode to be used for the connection will therefore be selected from said specific connection modes depending on the type of service required and/or the properties of the relevant ISP server.

Furthermore, for each connection mode supported by the network 5 and by the network access server 31, there is at least one service access server which is compatible with this connection mode and which is linked to the network 5. In other words, each connection mode has at least one service access server with which it is compatible.

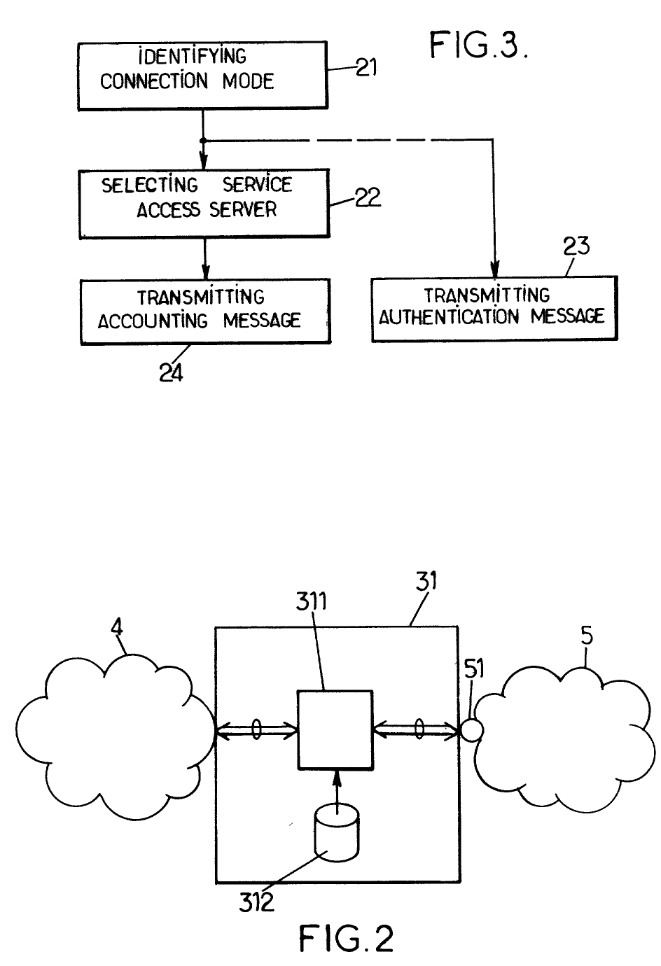

The diagram given in FIG. 2 illustrates an access server as proposed by the invention. In this drawing, elements common to FIG. 1 are shown by the same reference numbers.

The network access server 31 inter-connects the access network 4 and the transport network 5. To this end, it is connected to the first router 51 of the latter.

The network access server 31 has means for implementing the method proposed by the invention. In one example of an embodiment, these means are software means and form part of the profile of the server. This profile is stored in a memory 313 and run in a control unit 311 of the server 31.

The server 31 further has a database 312 which contains data determining connection modes, matching information which may be transmitted by the user terminal and which is specific to these respective connection modes.

The timing diagram of FIG. 3 shows the steps of the method proposed by the invention.

The method enables the transport network 5 to be accessed in order to set up a connection across this network between the user terminal 11, for example, and the server 2 of an ISP, using one specific connection mode of a plurality of different connection modes supported by the network. It may be recalled that, in practice, each connection mode is associated with one or more respective services to which the user may have access by connecting to the server of an ISP, such as the server 2.

The method starts with a step 21, which consists in identifying the connection mode of the connection on the basis of data transmitted by the user terminal. This data may include a call number associated with the server 2. In particular, this will be a telephone number if the access network is a telephone network. In addition or as an alternative, this data may include a “login” consisting of a user name and a password.

The data is compared with data of the same nature, stored in the database 312 of the network access server 31 (FIG. 2), with which data determining the corresponding connection mode is respectively associated. Accordingly, by reading this database, the connection mode of the connection can be identified from the data transmitted by the user terminal.

The method further comprises a step 22, which consists in selecting, depending on the connection mode identified at step 21, at least one service access server from a plurality of service access servers 61, 62, which are linked to the network 5. The service access server thus selected is compatible with the connection mode of the connection. In other words, the criterion on which this selection is based is the compatibility of the service access server or servers with the connection mode of the connection.

Finally, the method comprises a step 24, which consists in transmitting at least one accounting message associated with the connection to said at least one service access server selected at step 22. In particular, such a message, known as accounting start, is transmitted when the connection is established and another message, known as accounting stop, is transmitted when the connection is released. Depending on the type of connection mode, these messages are generated either by the user terminal 11 or by the network access server 31.

For certain connection modes, in particular the PPP and L2TP modes mentioned in the introduction, the method may further comprise a step 23 between step 22 and step 24, which consists in transmitting authentication messages associated with the connection to at least one service access server selected at step 22.

FIG. 4, in which elements common to FIG. 1 are denoted by the same reference numbers, illustrates one example of how the invention may be applied.

In this example, the access network 4 is the public switched telephone network (PSTN) run by the French operator FRANCE TELECOM.

The network access server 31 is located at a point of presence 30 or POP of the operator. This POP comprises several respective access networks of the operator or of different operators. Accordingly, in the example illustrated, the POP has another network access server 32 to inter-connect another access network (not illustrated), which may be the Integrated Services Digital Network or ISDN, for example.

The network 5 is an IP network (Internet Protocol). The POP 30, and in particular the network access server 31, enable the access network 4 to be inter-connected with a sub-network 5a of the network 5, which may be the core of the IP network of the operator FRANCE TELECOM, known as the “Réseau Backbone et Collecte Internet” or RBCI. It is a backbone network. The purpose of the NAS 31 is to direct the IP data flow picked up by the access network to the first router 51 of the RBCI, known as the concentrator node (or CN). The CN concentrates the different IP data flows coming from the various access networks linked to the POP 30 and transmits them to another router of the RBCI such as a regional node (RN) and/or to a transit node (TN), not illustrated, having higher routing capacities.

In this example, the network 5 also has other sub-networks 5b and 5c. The sub-network 5b is called the “Réseau d'Accès Entreprises Internet” or RAEI, and is run by TRANSPAC, a subsidiary of the operator FRANCE TELECOM. It is also an IP network. The sub-network 5c is the IP network of any ISP to which the server 2 of this ISP is linked, for example. The sub-network 5a and the sub-network 5b are inter-connected by a router 53. The sub-network 5a and the sub-network 5c are likewise inter-connected by router 55.

In this example, the first service access server 61 is also connected to the sub-network 5b whilst the second service access server 62 is connected to the sub-network 5b. The servers 61 and 62 are preferably RADIUS servers. In other words, they operate on the basis of the RADIUS protocol defined in RFC 2138. The server 61 is compatible with the PPP and L2TP connection modes but not with the TCP-Raw mode. However, the server 62 is compatible with the TCP-Raw mode. Consequently, given that the network 5 and the network access server 31, which is mutualized, support these three connection modes, the system has at least one service access server which is compatible with each of these connection modes. It should be pointed out that the system may have several compatible service access servers for at least some of these connection modes.

A user accesses the services of a given ISP by calling a specific telephone number via a user terminal such as 11, which comprises a modem, and is linked to the access network 4. This call is routed to the NAS 31 by the access network 4. A connection using the IP protocol is established between the terminal 11 and the server, such as 2, of the ISP. Depending on the specific case, this IP connection may be established using a given one of several connection modes specific to the accessed service or services and/or ISP.

When it is implemented within the network access server 31, the method proposed by the invention enables, in this particular example, the accounting messages and/or the authentication messages associated with connections in PPP mode or in L2TP mode to be transmitted to the RADIUS server 61, and accounting messages associated with connections in TCP-Raw mode to be transmitted to the RADIUS server 62 (it may be recalled that no authentication message is transmitted during this latter connection mode). In FIG. 4, the corresponding data flows are denoted by the broken lines 71, 72 and 73 respectively.

1. Method of accessing a packet mode network in order to establish a connection across the network between a user terminal and a server of a service provider using one specific connection mode from a plurality of different connection modes supported by the network, comprising the steps of:
identifying the specific connection mode on the basis of data transmitted by the user terminal;
depending on the specific connection mode, selecting at least one service access server from a plurality of service access servers such that the selected service access server is compatible with the specific connection mode;
transmitting at least one accounting message associated with the connection to the selected service access server.

2. Method as claimed in claim 1, further comprising the step of transmitting authentication messages associated with the connection to the selected service access server.

3. Method as claimed in one of claims 1 and 2, wherein each connection mode is associated with one or more respective services.

4. Method as claimed in one of the preceding claims, characterized in that it is implemented within a network access server.

5. Packet mode network access server for establishing a connection across the network between a user terminal and a server of a service provider using one specific connection mode of a plurality of different connection modes supported by the network, comprising:
means for identifying the specific connection mode on the basis of data transmitted by the user terminal;
depending on the specific connection mode, means for selecting at least one service access server from a plurality of service access servers such that the selected service access server is compatible with the specific connection mode;
means for transmitting at least one call accounting message to the selected service access server.

6. Server as claimed in claim 5, further comprising means for transmitting authentication messages associated with the connection to the selected service access server.

7. Server as claimed in one of claim 5 or 6, wherein each connection mode is associated with one or more respective services.

8. System comprising a packet mode network, at least one user terminal and at least one server of a service provider, a plurality of service access servers each compatible with at least one connection mode, and at least one network access server as claimed in one of claims 6 to 8 for establishing a connection across the network between the user terminal and the server of the service provider.

9. System a claimed in claim 8, further comprising an access network to which the user terminal is connected and which is inter-connected with the packet mode network by the network access server.

10. System as claimed in any one of claim 8 or 9, wherein the packet mode network is an IP network.

11. System as claimed in any one of claims 8 to 10, wherein the packet mode network is a backbone network.

12. System as claimed in any one of claims 8 to 11, wherein the service access servers are RADIUS servers.
